(19) United States
(12) Patent Application Publication
(10) Pub. No.: US 2005/0132075 A1
(43) Pub. Date: Jun. 16, 2005

(54) Authentication of mobile communication devices using mobile networks, SIP and Parlay

(75) Inventors: Thomas E. Creamer, Boca Raton, FL (US); Bill H. Hilf, La Habra, CA (US); Neil A. Katz, Parkland, FL (US); Victor S. Moore, Boynton Beach, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/736,389

(22) Filed: Dec. 15, 2003

(51) Int. Cl. G06F 15/16

(52) U.S. Cl. 709/229; 709/230

(57) ABSTRACT

A method of authenticating a mobile communication device can include forming a Session Initiation Protocol referred by token using authentication data provided by a mobile service provider over a mobile communications link and sending the token to a Session Initiation Protocol server via a wireless network. The Session Initiation Protocol server can send a request for validation, built using the token, to the mobile service provider using Parlay. A reply from the Session Initiation Protocol server can be received over the wireless network, wherein the reply indicates whether the request for validation from the Session Initiation Protocol server was confirmed.

### BACKGROUND

1. Field of the Invention

The invention relates to the field of mobile communications and, more particularly, to the use of wireless networking in conjunction with mobile networks.

2. Description of the Related Art

Wireless networks are becoming increasingly prevalent with thousands of so called hotspots being deployed throughout the United States, Europe, and Asia. A hotspot refers to the coverage area surrounding a wireless access point within which a device can communicate wirelessly with the access point. The access point typically includes a wireless transceiver and is connected to a packet-switched communications network such as the Internet. As such, the access point provides network connectivity to those devices capable of establishing a wireless communications link with the access point. Mobile users can roam between multiple hot spots while maintaining connectivity with a communications network. Examples of hotspots or wireless networks can include those networks built around one of the 802 wireless communications protocols such as 802.11, 802.16, 802.20, and 802.15.

Such wireless networks largely function independently of mobile communications networks. These wireless networks, particularly 802.11 wireless networks, often function purely as data networks. That is, typically voice communications are not carried over such networks. In consequence, the voice capability of mobile networks has yet to be integrated with 802.xx wireless networks.

### SUMMARY OF THE INVENTION

One aspect of the present invention can include a method of authenticating a mobile communication device. The method can include forming a Session Initiation Protocol referred by token using authentication data provided by a mobile service provider over a mobile communications link. The token can be sent to a Session Initiation Protocol server via a wireless network. The Session Initiation Protocol server can send a request for validation, built using the token, to the mobile service provider using Parlay. A reply from the Session Initiation Protocol server can be received over the wireless network. The reply can indicate whether the request for validation from the Session Initiation Protocol server was confirmed. The wireless network can be compliant with a communications protocol such as the 802.11, 802.16, 802.20, or 802.15 wireless communications protocol.

Another embodiment of the present invention can include a method of authenticating a mobile communication device including receiving a Session Initiation Protocol referred by token from the mobile communication device over a wireless network, wherein the token was built using authentication data provided by a mobile service provider received over a mobile communications link; interpreting the token and forming a Parlay request using data specified by the token; sending a request for validation of the mobile communication device to the mobile service provider using Parlay; receiving a response from the mobile service provider; and sending a reply to the mobile communication device over the wireless network indicating whether the request for validation was confirmed.

Another embodiment of the present invention can include a method of authenticating a mobile communication device including forming a Session Initiation Protocol referred by token using authentication data provided by the mobile service provider over a mobile communications link and sending the token to a Session Initiation Protocol server via a wireless network. The method also can include interpreting the token and forming a Parlay request for validation of the mobile device using data specified by the token and sending the Parlay request for validation to the mobile service provider. A response can be received from the mobile service provider and a reply can be sent to the mobile communication device over the wireless network indicating whether the request for validation was confirmed.

Another aspect of the present invention can include a system having means for performing the methods and techniques disclosed herein as well as a machine readable storage for causing a machine to perform the methods and techniques disclosed herein.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating one embodiment of a system for authenticating a mobile communication device.

FIG. 2 is a flow chart illustrating an embodiment of a method of authenticating a mobile communication device.

### DETAILED DESCRIPTION OF THE INVENTION

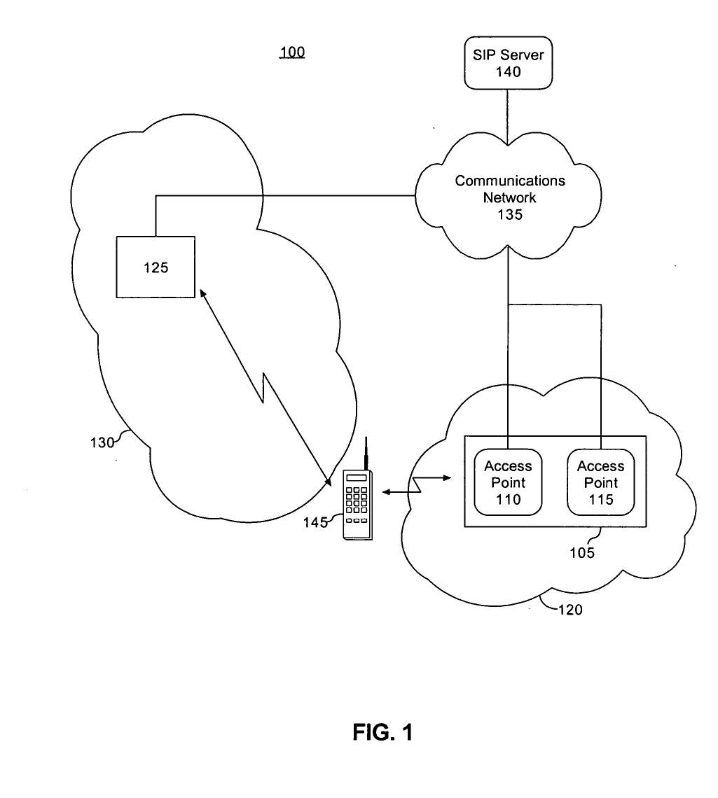

FIG. 1 is a schematic diagram illustrating a system 100 for authenticating a mobile communication device within a mobile communications network (mobile network) and a wireless communications network (wireless network) in accordance with the inventive arrangements disclosed herein. Authentication refers to the verification process that assures that a mobile communication device and user are compatible with and authorized to access a particular wireless or mobile network. This process can be accomplished through the transmission of identifying data at the time of connection. As shown, the system 100 can include a wireless network 105, a mobile network 125, a communications network 135, and a server 140.

The wireless network 105 can be a wireless network that is compliant with any suitable 802 communications protocol including, but not limited to, one of the 802.11, 802.16, 802.20, and/or 802.15 wireless communications protocols. For example, the wireless network can be configured according to the 802.11a, b, g, or 802.15.3 wireless communications protocols. As such, the wireless network 105 can include one or more access points 110 and 115. Access points 110 and 115 each can include a wireless transceiver for communicating with one or more mobile communication devices capable of communicating over an 802.xx compliant wireless connection, for example mobile communication device 145. Each access point 110 and 115 further can include a wired connection to the communications network 135. Accordingly, each access point 110 and 115 can be configured to serve as an interface between wireless or mobile communication devices communicating over an 802.xx communications protocol and the communications network 135. The wireless network 105 can have a coverage area 120 within which mobile communication device 145 can communicate over a wireless Voice-Over Internet Protocol (VOIP) channel or other wireless communications link.

The mobile network 125, operated by a mobile service provider, can include any of a variety of different wireless telephony networks including, but not limited to, a conventional cellular telephony network or a Personal Communications Service (PCS) network (hereafter referred to as a “mobile network”). The mobile network 125 can include one or more Mobile Data Base Stations (not shown) and a Mobile Switching Center (not shown). As such, the mobile network 125 can include the hardware and/or software necessary for wirelessly communicating with the mobile communication device 145, routing calls, and providing information such as user registration, authentication, and location updating. The mobile network 125 can have a coverage area 130 within which mobile communication device 145 can wirelessly communicate with the mobile service provider over a mobile communications link.

The communications network 135 can include the Internet, a Wide Area Network, a Local Area Network, wireless networks, intranets, or any other packet switched network. SIP server 140 can be a program executing within a suitable information processing system such as a server. Accordingly, SIP server 140 can decode SIP tokens received from the mobile communication device 145 and format validation requests using Parlay to be sent to a mobile service provider. For example, in one embodiment of the present invention, the SIP server 130 can be implemented as a Web site or Web server.

SIP is a standard protocol for initiating interactive user sessions that involve multimedia elements such as video, voice, chat, gaming, and virtual reality. SIP works in the Application layer of the Open Systems Interconnection (OSI) communications model to establish, modify, and terminate multimedia sessions or Internet telephony calls. The protocol also can be used to invite participants to unicast or multicast sessions that do not necessarily involve the initiator. Because SIP supports name mapping and redirection services, SIP allows users to initiate and receive communications and services from any location, and for networks to identify the users wherever the user may be located.

SIP is a request-response protocol, dealing with requests from clients and responses from servers. Participants are identified by SIP Uniform Resource Locators (URL's). Requests can be sent through any transport protocol, such as User Datagram Protocol (UDP), Stream Control Transmission Protocol (SCTP), or Transmission Control Protocol (TCP). SIP determines the end system to be used for the session, the communication media and media parameters, and the called party's desire to engage in the communication. Once these parameters are assured, SIP establishes call parameters at either end of the communication, and handles call transfer and termination.

The mobile communication device 145 can be configured to communicate over the mobile network 125 as well as the wireless network 105. The mobile communication device 145 can include transceivers for communicating over both mobile networks and wireless networks. In addition, the mobile communication device 145 can include a SIP user agent executing therein. The SIP user agent can encode and decode SIP formatted messages which are exchanged over the wireless network 105. In one embodiment of the present invention, the mobile communication device 145 can be implemented as a mobile phone. Still, those skilled in the art will recognize that any communication device configured as described herein can be used.

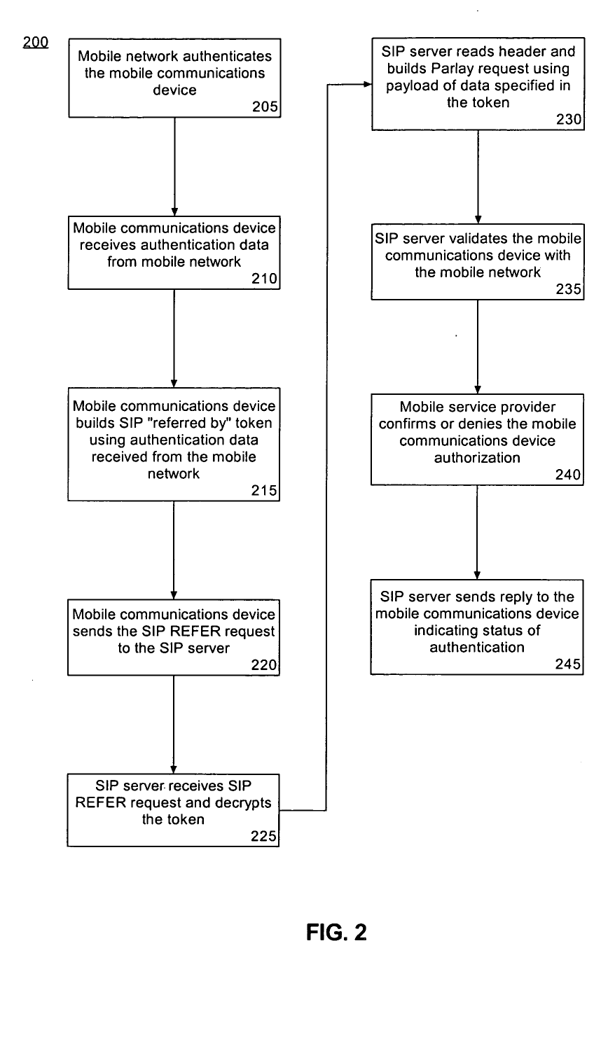

FIG. 2 is a flow chart illustrating a method 200 of validating a mobile communication device with a mobile network in accordance with one aspect of the present invention. The method 200 can begin in a state where a user has a mobile communication device, such as a telephone, that is configured to communicate over mobile networks and an 802.xx compliant wireless network. Further, the mobile communication device can include a SIP user agent executing therein.

The method 200 can begin in step 205 where the mobile communication device is within communication range of a mobile network, and therefore a mobile service provider. In step 205, the mobile network can authenticate the mobile communication device over a mobile communications link. The mobile communication device can be authenticated using standard mobile network communications protocols and methods such as an Electronic Serial Number (ESN) based process. The ESN is a 32-bit identifier of an Advanced Mobile Phone Service (AMPS). It should be appreciated, however, that any of a variety of identifiers can be used, such as a Mobility Event Indicator (MEI) or the like depending upon the particular configuration of the mobile network. This process involves the authentication of the mobile communications device during the initial power on sequence. This involves the passing of relevant data, such as ESN, using mobile communications protocols. This data is stored in the Home Location Register (HLR) and is the basis for authentication of the mobile communications device.

In step 210, the mobile communication device can receive authentication data from the mobile network. In step 215, the mobile communication device, for example the SIP agent disposed within the device, can build a SIP “referred by” token using authentication data received from the mobile network. The SIP REFER method provides a mechanism where one party (the referrer) gives a second party (the referee) an arbitrary Uniform Resource Indicator (URI) to reference. If that URI is a SIP URI, the referee will send a SIP request, often an INVITE, to that URI (the refer target). This document extends the REFER method allowing the referrer to provide information about the REFER request to the refer target using the referee as an intermediary. This information can include the identity of the referrer and the URI to which the referrer referred. The mechanism utilizes S/MIME to help protect this information from a malicious intermediary. This protection is optional, but a recipient may refuse to accept a request unless it is present. Further detail regarding the SIP REFER method is disclosed in “The Session Initiation Protocol (SIP) Refer Method”, Request For Comments (RFC) 3515, which is fully incorporated by reference.

In one embodiment of the present invention, the token can be encrypted and signed using the Authorization Identity Body (AIB) method and formatted as defined in the Internet Draft of SIP-AIBF. Internet-Drafts are working documents of the Internet Engineering Task Force (IETF). AIB's are mechanisms for sharing an authenticated identity among parties in a network. The AIB format is a special type of MIME body format that allows a party in a SIP transaction to cryptographically sign the headers that assert the identity of the originator of a message. AIB's provide other headers that may be necessary for reference integrity.

In step 220, the mobile communication device sends the SIP REFER request to the SIP server. That is, the mobile communication device sends the SIP REFER request wirelessly to a wireless access point within a wireless network conforming with one of the 802 wireless communications protocols as described herein. The SIP REFER request is forwarded to the SIP server via the Internet or another packet-switched network. In step 225, the SIP server receives the SIP REFER request and decrypts the token.

In step 230 the SIP server reads the header data of the token and builds a Parlay request based upon the payload data specified by the token. The payload data specifies authentication data received from the mobile network in step 205. In step 235 the SIP server validates the mobile communication device with the mobile network. More particularly, the SIP server sends a Parlay Presence and Availability Management (PAM) Application Programming Interface (API) request over a packet-switched network such as the Internet to the mobile network or mobile service provider.

Parlay PAM API's facilitate exportation and management of presence information in a network and policy and/or preference-based availability of users. Parlay PAM API's provide this functionality independently of network architecture and independent of transport/application protocols. As such, Parlay PAM API's facilitate the creation of presence-based applications and services, independently of the underlying networks and access protocols; facilitate the publication and sharing of presence information across networks with privacy and security controls; provide an overarching PAM Infrastructure within Parlay; and extend the location information APIs to other types of presence information and provide policy/preference-based controls for sharing or publishing the information.

After receiving the Parlay PAM API request, the mobile service provider confirms or denies the mobile communication device authorization in step 240 by sending a reply to the SIP server. Within the reply, the mobile service provider can specify information such as a valid telephone number (TN), user identity (ID), and/or possibly an availability status. In step 245, the SIP server can send a reply to the mobile communication device indicating whether the authentication was confirmed or denied by the mobile service provider.

The present invention can be realized in hardware, software, or a combination of hardware and software. Aspects of the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

Aspects of the present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of authenticating a mobile communication device comprising:
forming a Session Initiation Protocol referred by token using authentication data provided by a mobile service provider over a mobile communications link;
sending the token to a Session Initiation Protocol server via a wireless network, wherein the Session Initiation Protocol server sends a request for validation, built using the token, to the mobile service provider using Parlay; and
receiving a reply from the Session Initiation Protocol server over the wireless network, wherein the reply indicates whether the request for validation from the Session Initiation Protocol server was confirmed.

2. The method of claim 1, wherein the wireless network is compliant with at least one of an 802.16, 802.20, or 802.15 wireless communications protocol.

3. The method of claim 1, wherein the wireless network is compliant with an 802.11 wireless communications protocol.

4. A method of authenticating a mobile communication device comprising:
receiving a Session Initiation Protocol referred by token from the mobile communication device over a wireless network, wherein the token was built using authentication data provided by a mobile service provider received over a mobile communications link;
interpreting the token and forming a Parlay request using data specified by the token;
sending a request for validation of the mobile communication device to the mobile service provider using Parlay;
receiving a response from the mobile service provider; and
sending a reply to the mobile communication device over the wireless network indicating whether the request for validation was confirmed.

5. The method of claim 4, wherein the wireless network is compliant with at least one of an 802.16, 802.20, or 802.15 wireless communications protocol.

6. The method of claim 5, wherein the wireless network is compliant with an 802.11 wireless communications protocol.

7. A method of authenticating a mobile communication device comprising:
forming a Session Initiation Protocol referred by token using authentication data provided by the mobile service provider over a mobile communications link;
sending the token to a Session Initiation Protocol server via a wireless network;
interpreting the token and forming a Parlay request for validation of the mobile device using data specified by the token;
sending the Parlay request for validation to the mobile service provider;
receiving a response from the mobile service provider; and
sending a reply to the mobile communication device over the wireless network indicating whether the request for validation was confirmed.

8. The method of claim 7, wherein the wireless network is compliant with at least one of an 802.16, 802.20, or 802.15 wireless communications protocol.

9. The method of claim 7, wherein the wireless network is compliant with an 802.11 wireless communications protocol.

10. A mobile communication device for communicating over a wireless network and a mobile network comprising:
means for forming a Session Initiation Protocol referred by token using authentication data provided by a mobile service provider over a mobile communications link;
means for sending the token to a Session Initiation Protocol server via a wireless network, wherein the Session Initiation Protocol server sends a request for validation, built using the token, to the mobile service provider using Parlay; and
means for receiving a reply from the Session Initiation Protocol server over the wireless network, wherein the reply indicates whether the request for validation from the Session Initiation Protocol server was confirmed.

11. The mobile communication device of claim 10, wherein the wireless network is compliant with at least one of an 802.16, 802.20, or 802.15 wireless communications protocol.

12. The mobile communication device of claim 10, wherein the wireless network is compliant with an 802.11 wireless communications protocol.

13. A system for authenticating a mobile communication device comprising:
means for receiving a Session Initiation Protocol referred by token from a mobile communication device over a wireless network, wherein the token was built using authentication data provided by a mobile service provider;
means for interpreting the token and forming a Parlay request using data specified by the token;
means for sending a request for validation of the mobile communication device to the mobile service provider using Parlay;
means for receiving a response from the mobile service provider; and
means for sending a reply to the mobile communication device over the wireless network indicating whether the request for validation was confirmed.

14. The system of claim 13, wherein the wireless network is compliant with at least one of an 802.16, 802.20, or 802.15 wireless communications protocol.

15. The system of claim 13, wherein the wireless network is compliant with an 802.11 wireless communications protocol.

16. A system for authenticating a mobile communication device comprising:
means for forming a Session Initiation Protocol referred by token using authentication data provided by the mobile service provider over a mobile communications link;
means for sending the token to a Session Initiation Protocol server via a wireless network;
means for interpreting the token and forming a Parlay request for validation of the mobile device using data specified by the token;
means for sending the Parlay request for validation to the mobile service provider;
means for receiving a response from the mobile service provider; and
means for sending a reply to the mobile communication device over the wireless network indicating whether the request for validation was confirmed.

17. The system of claim 16, wherein the wireless network is compliant with at least one of an 802.16, 802.20, or 802.15 wireless communications protocol.

18. The system of claim 16, wherein the wireless network is compliant with an 802.11 wireless communications protocol.

19. A machine readable storage, having stored thereon a computer program having a plurality of code sections executable by a machine for causing the machine to perform the steps of:
forming a Session Initiation Protocol referred by token using authentication data provided by a mobile service provider over a mobile communications link;
sending the token to a Session Initiation Protocol server via a wireless network, wherein the Session Initiation Protocol server sends a request for validation, built using the token, to the mobile service provider using Parlay; and
receiving a reply from the Session Initiation Protocol server over the wireless network, wherein the reply indicates whether the request for validation from the Session Initiation Protocol server was confirmed.

20. The machine readable storage of claim 19, wherein the wireless network is compliant with at least one of an 802.16, 802.20, or 802.15 wireless communications protocol.

21. The machine readable storage of claim 19, wherein the wireless network is compliant with an 802.11 wireless communications protocol.

22. A machine readable storage, having stored thereon a computer program having a plurality of code sections executable by a machine for causing the machine to perform the steps of:
receiving a Session Initiation Protocol referred by token from a mobile communication device over a wireless network, wherein the token was built using authentication data provided by a mobile service provider received over a mobile communications link;
interpreting the token and forming a Parlay request using data specified by the token;
sending a request for validation of the mobile communication device to the mobile service provider using Parlay;
receiving a response from the mobile service provider; and
sending a reply to the mobile communication device over the wireless network indicating whether the request for validation was confirmed.

23. The machine readable storage of claim 22, wherein the wireless network is compliant with at least one of an 802.16, 802.20, or 802.15 wireless communications protocol.

24. The machine readable storage of claim 22, wherein the wireless network is compliant with an 802.11 wireless communications protocol.
